(19) United States
(12) Patent Application Publication
(10) Pub. No.: US 2025/0163301 A1
(43) Pub. Date: May 22, 2025

(54) PRESSURE-SENSITIVE ADHESIVE SHEET

(71) Applicant: NITTO DENKO CORPORATION, Osaka (JP)

(72) Inventors: Yasuhito Inai, Osaka (JP); Shuhei Yamamoto, Osaka (JP)

(73) Assignee: NITTO DENKO CORPORATION, Osaka (JP)

(21) Appl. No.: 18/947,276

(22) Filed: Nov. 14, 2024

(30) Foreign Application Priority Data
Nov. 20, 2023 (JP) 2023-196371

(51) Int. Cl. C09J 7/38; C09J 7/29

(52) U.S. Cl. CPC C09J 7/385; C09J 7/29; C09J 2301/124; C09J 2301/302

(57) ABSTRACT

To provide a PSA sheet comprising a substrate layer with colored layer and a PSA layer while being capable of showing excellent holding power. Provided is a PSA sheet that comprises a PSA layer formed from a water-dispersed PSA composition comprising an acrylic polymer as a base polymer, and a support substrate in the form of a sheet having first and second faces, supporting the PSA layer at least on the first face. The substrate comprises a colored layer forming the first face. The colored layer forming the first face comprises an ether-based polyurethane.

### CROSS-REFERENCE

The present application claims priority to Japanese Patent Application No. 2023-196371 filed on Nov. 20, 2023 and the entire content thereof is herein incorporated by reference.

### BACKGROUND OF THE INVENTION

### 1. Field of the Invention

The present invention relates to a pressure-sensitive adhesive sheet that comprises a substrate having a colored layer and a pressure-sensitive adhesive layer.

### 2. Description of the Related Art

In general, pressure-sensitive adhesive (PSA) exists as a soft solid (a viscoelastic material) in a room temperature range and has a property to adhere easily to adherend with some pressure applied. Because of such properties, PSA has been widely used as a PSA sheet with substrate in which a PSA layer is provided to one or each face of a substrate. For instance, colored PSA sheets are used in various applications including electronic devices such as mobile phones, tablet computers, and laptop computers to provide electrical insulation, concealment, light blocking, visibility, and design features. Technical documents relating to this type of PSA sheet include Japanese Patent Application Publication No. 2013-72074 and Japanese Patent Application Publication No. 2013-203965.

### SUMMARY OF THE INVENTION

Japanese Patent Application Publication No. 2013-72074 and No. 2013-203965 describe a PSA sheet produced by printing a colored layer on the surface of a resin film as a substrate and providing a PSA layer atop the colored layer by a transfer method. Here, in the transfer method, a PSA composition is applied to a release liner as in-process paper and allowed to dry to form a PSA layer on the release liner, and then the PSA layer is adhered to a substrate to transfer the PSA layer onto the substrate. On the other hand, the method by which a PSA layer is formed by directly applying a PSA composition to a substrate and drying is called the direct application method (or “direct method” hereinafter). In comparison to forming a PSA layer by the transfer method, the direct method has the advantage in manufacturing that it does not require a release liner as an in-process paper.

However, when forming a PSA layer by the direct method on a substrate with a colored layer on the surface, components of the colored layer migrate from the colored layer of the substrate into the PSA composition, which can negatively affect the properties of the PSA layer. For instance, when using a crosslinking agent and the like to control the crosslinked structure of the base polymer in the PSA layer for property control, the colored layer components that have migrated into the PSA composition can inhibit the crosslinking reaction, resulting in a decrease in holding power of the PSA layer.

The present invention has been made in view of the above points with an objective to provide a PSA sheet that comprises a PSA layer and a substrate having a colored layer and an adhesive layer, and that can show excellent holding power.

As a result of earnest studies, the present inventors have found that when the colored layer of the substrate includes at least an ether-based polyurethane, crosslinking inhibition tends to occur in the PSA layer. In addition, it has been found out that when the PSA layer is formed by using a water-dispersed PSA composition comprising adhesive components dispersed in an aqueous medium, crosslinking inhibition caused by colored layer components is readily suppressed, even with the PSA layer having been formed by a direct method on the substrate.

This description provides a PSA sheet that comprises a PSA layer formed from a water-dispersed PSA composition comprising an acrylic polymer as a base polymer, and a support substrate in the form of a sheet having first and second faces, supporting the PSA layer at least on the first face. Here, the substrate comprises a colored layer forming the first face, and the colored layer comprises an ether-based polyurethane. In such an embodiment, the PSA layer placed in contact with the colored layer of the substrate is formed from a water-dispersed PSA composition; and therefore, crosslink inhibitors are unlikely to migrate from the colored layer, and crosslinking inhibition is readily suppressed in the PSA layer. Thus, in the PSA sheet, reduction of holding power tends to be suppressed.

In some embodiments, the acrylic polymer is (i) formed from monomers including a silanol-forming monomer and crosslinked with silanol groups originating from the silanol-forming monomer, or (ii) crosslinked with one, two or more species of crosslinking agents selected among oxazoline-based crosslinking agents, carbodiimide-based crosslinking agents, epoxy-based crosslinking agents and isocyanate-based crosslinking agents.

The silanol-forming monomer in (i) is a polymerizable compound that has at least one (preferably two or more, e.g., two or three) silanol-forming functional group(s) (functional group(s) capable of forming a silanol group (Si—OH)) per molecule. Favorable examples of the silanol-forming functional group include a functional group (alkoxysilyl group, etc.) that forms a silanol group by hydrolysis. By using such a silanol-forming monomer as a monomer, a crosslinked structure is introduced into the acrylic polymer through condensation reaction of silanol groups. According to the art disclosed herein, with respect to the crosslinking reaction of such a silanol-forming monomer (i.e., condensation reaction of silanol groups), crosslinking inhibition is suitably suppressed. Thus, when an acrylic polymer crosslinked with a silanol-forming monomer is used as the acrylic polymer in the PSA layer, reduction of holding power caused by crosslinking inhibition is less likely to occur.

According to the art disclosed herein, crosslinking inhibition is also suitably suppressed in the crosslinking reaction with the crosslinking agent described in (ii), that is, one, two or more species of crosslinking agents selected among oxazoline-based crosslinking agents, carbodiimide-based crosslinking agents, epoxy-based crosslinking agents and isocyanate-based crosslinking agents. Thus, when an acrylic polymer crosslinked with the crosslinking agent is used as the acrylic polymer in the PSA layer, reduction of holding power caused by crosslinking inhibition is less likely to occur.

In some embodiments, the PSA layer has a thickness of 10 μm or greater and 50 μm or less. According to the art disclosed herein, even when the PSA sheet has a relatively thin PSA layer, the effect of crosslink inhibitors from the colored is suppressed, helping to suppress reduction of holding power.

In some embodiments, the substrate comprises a first colored layer forming the first face and a second colored layer forming the second face, with first and second PSA layers placed on the first and second faces of the substrate, respectively. Such an embodiment helps bring about a double-faced PSA sheet that comprises a substrate having colored layers and also exhibits excellent holding power.

### BRIEF DESCRIPTION OF THE DRAWINGS

FIG. 1 shows a schematic cross-sectional diagram illustrating the PSA sheet according to an embodiment.

FIG. 2 shows a schematic cross-sectional diagram illustrating the PSA sheet according to another embodiment.

### DETAILED DESCRIPTION OF THE INVENTION

Preferred embodiments of the present invention are described below. Matters necessary to practice this invention other than those specifically referred to in this description can be understood by a person skilled in the art based on the disclosure about implementing the invention in this description and common general knowledge at the time of application. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate size or reduction scale of an actual product provided.

The term “PSA” in this description refers to a material present in a soft solid (viscoelastic) state in a room temperature range and has a property to adhere to adherend with some pressure applied. As defined in “Adhesion: Fundamentals and Practice” by C. A. Dahlquist (McLaren & Sons (1966), P. 143), the PSA referred to herein can be a material having a property that satisfies complex tensile modulus E* (1 Hz)<10⁷ dyne/cm² (typically, a material exhibiting the described characteristics at 25° C.). The PSA in the art disclosed herein can be considered as solid contents (non-volatiles) in a PSA composition or constituents of a PSA layer.

As used herein, the term “(meth)acryloyl” comprehensively refers to acryloyl and methacryloyl. Similarly, the term “(meth)acrylate” comprehensively refers to acrylate and methacrylate, and the term “(meth)acryl” comprehensively refers to acryl and methacryl.

The term “acrylic polymer” in this description refers to a polymer comprising, as a monomeric unit constituting the polymer, more than 50% by weight of a monomeric unit derived from an acrylic monomer. The acrylic monomer refers to a monomer derived from a monomer having at least one (meth)acryloyl group per molecule.

The term “water-dispersed” in the present description refers to a state where components are at least partially dispersed in water. For instance, the term “water-dispersed PSA composition” refers to a composition comprising a PSA composition and water while being in a state where the PSA composition is at least partially dispersed in water. The water-dispersed state also includes a suspended state and an emulsified state.

### <PSA Sheet>

### (Examples of Configuration of PSA Sheet)

The PSA sheet disclosed herein is a PSA sheet with substrate having a PSA layer on one or each face of a substrate (support). The concept of a PSA sheet as used herein may encompass so-called PSA tape, PSA label and PSA film. The PSA layer is typically formed continuously, but is not limited to such a configuration. It may instead be formed in a regular or random pattern of dots, stripes, etc. The PSA sheet may be in a roll form or a flat sheet form. Alternatively, the PSA sheet may be in a form that has been fashioned into any of various other shapes.

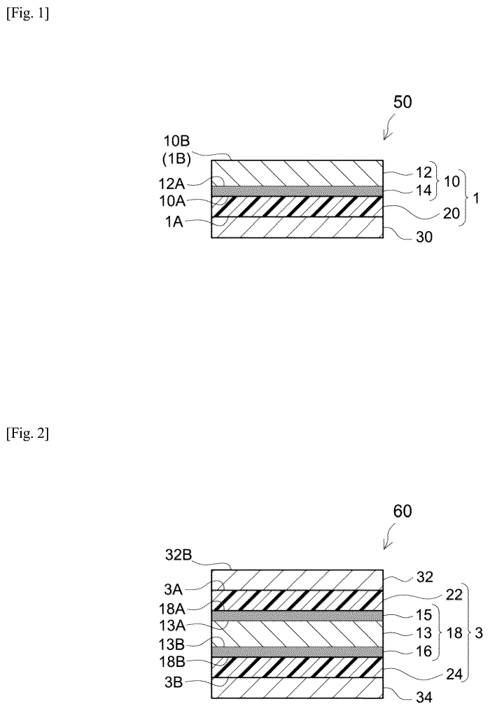

The PSA sheet disclosed herein may have, for instance, a cross-sectional structure schematically illustrated in FIG. 1. PSA sheet 1 shown in FIG. 1 is constituted as an adhesively single-faced PSA sheet with substrate, the PSA sheet having a sheet of substrate (support) 10, and a PSA layer 20 provided to a surface 10A (non-releasable) of substrate 10. In PSA sheet 1, the surface of PSA layer 20 is a bonding surface (adhesive face) 1A constituting one surface of PSA sheet 1. In PSA sheet 1, the other surface 10B of substrate 10 forms the other surface (back (backside)) 1B of PSA sheet 1. That is, the other surface 10B of substrate 10 serves as the second surface (backside) 1B of PSA sheet 1. Substrate 10 comprises a substrate film 12 and a colored layer 14 placed on the substrate film 12's front side (i.e., the PSA layer 20 side (first surface 12A) of substrate film 12). Colored layer 14 forms the surface 10A on the PSA layer 20 side of substrate 10. In other words, PSA sheet 1 has a layered structure in which colored layer 14 and PSA layer 20 are laminated in this order on the first surface 12A of substrate film 12.

As shown in FIG. 1, PSA sheet 1 before use (before application to an adherend) may be in the form of a release-linered PSA sheet 50, in which the adhesive face 1A is protected with a release liner 30 of which at least the PSA layer 20 side is a release face. Alternatively, it can be a PSA sheet without release liner 30, but with the other face (backside) 10B of substrate 10 being a release face, such that when PSA sheet 1 is wound into a roll, the backside 10B comes in contact with PSA layer 20 and protects its surface (adhesive face 1A).

In another embodiment, the PSA sheet disclosed herein may have a cross-sectional structure as schematically illustrated in FIG. 2. PSA sheet 3 shown in FIG. 2 is constituted as an adhesively double-faced PSA sheet with substrate that has a sheet of substrate (support) 18 as well as a first PSA layer 22 and a second PSA layer 24 supported on the respective faces of substrate 18. More specifically, the first and second PSA layers 22 and 24 are provided to the first and second faces 18A and 18B (both non-releasable) of substrate 18, respectively. In PSA sheet 3, the surface of the first PSA layer 22 is an adhesive face (PSA face) 3A forming one surface of PSA sheet 3, and the surface of the second PSA layer 24 is an adhesive face (PSA face) 3B forming the other surface of PSA sheet 3. Substrate 18 comprises a substrate film 13, a first colored layer 15 placed on the first PSA layer 22 side of substrate film 13, and a second colored layer 16 placed on the second PSA layer 24 side of substrate film 13. The first colored layer 15 forms the surface 18A on the first PSA layer 22 side of substrate 18, and the second colored layer 16 forms the surface 18B on the second PSA layer 24 side of substrate 18. In other words, PSA sheet 3 has a layered structure in which the first colored layer 15 and the first PSA layer 22 are laminated in this order on the first surface 13A of substrate film 13, and the second colored layer 16 and the second adhesive layer 24 are laminated in this order on the second surface 13B of substrate film 13.

As shown in FIG. 2, PSA sheet 3 before use (before application to an adherend) may be in the form of a release-linered PSA sheet 60, in which the adhesive face 3A is protected with a release liner 32 of which at least the first PSA layer 22 side is a release face, and the adhesive face 3B is protected with a release liner 34 of which at least the second PSA layer 24 side is a release face. Alternatively, it can be a PSA sheet without release liner 34, but with the backside 32B (opposite to the first PSA layer 22 side) of release liner 32 being a release face, such that when PSA sheet 3 is wound into a roll, the backside 32B comes in contact with the second PSA layer 24 and protects its surface (adhesive face 3B).

### (Substrate)

The PSA sheet disclosed herein comprises a sheet of substrate (support) supporting the PSA layer. In some embodiments, the substrate comprises a substrate film (base film) and a colored layer provided onto the substrate film.

(Substrate film)

The substrate film (base film) is not particularly limited. For instance, it is preferable to use a resin film comprising a resin material as a primary component (e.g., a component accounting for more than 50% by weight. As used herein, the term “resin film” typically refers to an essentially unfoamed resin film. In other words, the resin film herein can be essentially free of internal pores (void-free). Thus, the resin film is conceptually distinguished from so-called foam film. The resin film is typically a substantially non-porous film and conceptually distinguished from nonwoven and woven fabrics. It is preferable to use a substrate film free of a porous layer such as foam and woven/nonwoven fabrics, that is, a substrate film formed of a non-porous layer. Resin film generally tends to have superior mechanical strength such as tensile strength when compared to foam and woven/nonwoven fabrics. It also shows excellent processability (e.g., for punching). Thus, a PSA sheet using a resin-film-containing substrate is advantageous in terms of processability, size accuracy, and handling properties. Also, in view of size stability, thickness accuracy, cost, etc., a substrate comprising such a resin film can be preferably used as the substrate in the art disclosed herein.

Favorable examples of the resin material forming the resin film disclosed herein include polyolefinic resin and polyester resin. Here, polyolefinic resin comprises more than 50% polyolefin by weight. Likewise, polyester resin comprises more than 50% polyester by weight. Examples of polyolefinic resin film include polyethylene (PE) resin, polypropylene (PP) resin, ethylene-propylene copolymer and ethylene-butene copolymer. Examples of polyester resin include polyethylene terephthalate (PET) resin, polybutylene terephthalate (PBT) resin, polyethylene naphthalate resin, and polybutylene naphthalate resin. Among them, in view of anchoring properties (especially, anchoring properties of acrylic PSA layers), polyester resin is preferable. In view of strength and processability, PET resin is particularly preferable.

To the substrate film (e.g., resin film), as necessary, various additives can be added, such as a filler (inorganic filler, organic filler, etc.), anti-aging agent, antioxidant, UV absorber, anti-static agent, slip agent, and plasticizer. The amount of various additives is typically about less than 30% by weight (e.g., less than 20% by weight, typically less than 10% by weight).

As the substrate film (e.g., resin film), a transparent film (e.g., transparent resin film) can be preferably used. In view of strength, etc., the substrate film may be essentially free of a colorant. Here, that the substrate film is essentially free of a colorant indicates that the colorant content is less than 1% by weight, or preferably less than 0.1% by weight. Alternatively, to obtain desirable design features and optical properties (e.g., light-blocking properties, etc.) with the PSA sheet, the substrate film in the art disclosed herein may be colored black, white (e.g., milky white), or other colors. It can be colored, for instance, by adding a known organic or inorganic colorant (pigment, dye, etc.) to the material forming the substrate film.

The substrate film disclosed herein may have a monolayer structure or a multilayer structure with two, three or more layers. From the standpoint of the shape stability, the substrate film preferably has a monolayer structure. The method for producing the substrate film (typically a resin film) is not particularly limited and a heretofore known method can be suitably employed. For instance, heretofore known general film-forming methods can be suitably employed, such as extrusion, inflation molding, T-die casting, and calender rolling.

The surface of the substrate film (e.g., resin film) may be subjected to heretofore known surface treatments such as corona discharge treatment, plasma treatment, UV irradiation, acid treatment, base treatment and primer coating (primer layer formation). These surface treatments may increase the adhesion of the substrate film and the colored layer laminated to the surface thereof and the adhesion of the substrate film to the PSA layer. The art disclosed herein can be preferably implemented in an embodiment where no primer layer is formed between the substrate film and the layer laminated to the surface thereof and/or between the substrate film and the PSA layer while the substrate film is in direct contact with the layer laminated to the surface thereof and/or with the PSA layer. The PSA sheet in such an embodiment can be made thinner.

The substrate film thickness is not particularly limited. In some embodiments, the substrate film has a thickness of, for instance, about 200 μm or less, possibly about 100 μm or less, 70 μm or less, or even 50 μm or less. By reducing the substrate film thickness, the PSA sheet can also be made thinner. This can also be advantageous in terms of making the products to which the PSA sheet is applied thinner, smaller, lighter, and resource-saving. In view of ease of handling, processing, etc., the minimum substrate film thickness is preferably about 0.5 μm or greater (e.g., 1 μm or greater). In other embodiments, in view of handling properties, etc., the substrate film thickness may be 5 μm or greater, 10 μm or greater, 15 μm or greater, or even 20 μm or greater. In some preferable embodiments, the substrate film thickness is, for instance, 1 μm or greater and 100 μm or less, more preferably 10 μm or greater and 80 μm or less, or particularly preferably 25 μm or greater and 75 μm or less.

### (Colored Layer)

The substrate disclosed herein includes a colored layer. In particular, the colored layer is laminated on the PSA layer side of the substrate film and placed between the substrate film and the PSA layer. In an embodiment of the PSA sheet formed as an adhesively single-faced PSA sheet having a PSA layer on one face of the substrate, the colored layer is placed to form at least the PSA layer side surface of the substrate. In an embodiment of the PSA sheet formed as an adhesively double-faced PSA sheet having a PSA layer on each face of the substrate, a colored layer is placed to form at least one PSA layer side surface of the substrate; preferably, two or more colored layers are placed to form the two respective PSA layer side surfaces. As compared with the embodiment with one face of the substrate having a colored layer, the embodiment with both faces of the substrate having colored layers helps reduce the surface roughness of the colored layers as well as that of the PSA layer, thereby likely increasing the adhesion to the adherend with improved adhesive properties. In addition, when a PSA layer is provided onto a colored layer, the anchoring between the substrate and the PSA layer tends to improve as compared with when a PSA layer is provided to a substrate surface lacking a colored layer. The art disclosed herein allows a high degree of freedom in manufacturing for providing a PSA layer on the colored layer side of the substrate; and therefore, the resulting PSA sheet tends to have strong anchoring between the substrate and the PSA layer.

With the substrate including a colored layer, the color and transparency of the PSA sheet can be adjusted to obtain desirable design features, light-blocking properties, and concealability. The color of the colored layer is not particularly limited and various colors can be selected in accordance with the purpose. In some preferable embodiments, the colored layer can be, for instance, a black-colored layer (black print layer) formed by black color printing. For instance, the PSA sheet having a black-colored layer as the colored layer can be preferably applied to a module requiring electrical insulation.

The colored layer can be formed, for instance, by coating a substrate film with a colored-layer-forming composition comprising a colorant and a binder. As the binder, materials known in the paint or print field can be used without particular limitations. Examples include polyurethane, phenol resin, epoxy resin, urea melamine resin, and polymethyl methacrylate.

Studies by the present inventors have found that when the colored layer includes an ether-based polyurethane as a binder, there is a tendency for the occurrence of inhibition of PSA crosslinking during the PSA layer formation. Thus, it is particularly meaningful to apply the art disclosed herein to an embodiment where the colored layer includes an ether-based polyurethane as the binder. Here, as used herein, the ether-based polyurethane refers to a polyurethane whose main chain is formed of ether bonds. Typically, it refers to a polyurethane produced by the reaction of an ether-based polyol (e.g., polyether polyol) with a polyisocyanate.

In some embodiments, the amount of ether-based polyurethane in the total amount of binder in the colored layer disclosed herein is above 50% by weight, possibly 70% by weight or greater, 85% by weight or greater, or even 90% by weight or greater (e.g., 100% by weight). According to the art disclosed herein, even when the ether-based polyurethane content increases, crosslinking inhibition can be favorably suppressed to reduce the decrease in holding power.

The colored-layer-forming composition can be, for instance, solvent-based, UV-curable, heat-curable, etc. The colored layer can be formed by employing a method conventionally used for forming colored layers without particular limitations. Examples of preferable methods for forming colored layers (print layers) include printing such as gravure printing, flexographic printing, and offset printing.

The colored layer may have a monolayer structure formed entirely of one layer or a multilayer structure including two, three, or more colored sublayers. A colored layer having a multilayer structure with two or more colored sublayers can be formed, for instance, by repeated application (e.g., printing) of the colored-layer-forming composition. The colors and amounts of the colorants in the respective colored sublayers can be the same or different. With respect to a colored layer to provide light-blocking properties, having a multilayer structure is particularly significant in view of preventing pinhole formation to increase reliability for light leak prevention.

As the colorant used for layer coloring, known pigments and dyes can be suitably selected in accordance with the target color. While no particular limitations are imposed, examples of white pigments include titanium dioxide, zinc white, and lead white. Examples of black pigments include carbon black, acetylene black, pine smoke, and graphite. Among these, solely one species or a combination of two or more species can be used.

The colorant content is set in accordance with the required color, texture, etc. Thus, it is not limited to a specific range. Of the colored layer, it accounts for suitably about 1% by weight or more, preferably 2% by weight or more (e.g., 5% by weight or more), or possibly 15% by weight or more. The colorant content is suitably about 65% by weight or less, preferably 30% by weight or less (e.g., 15% by weight or less), or even 8% by weight or less.

In an embodiment where the colored layer forms at least one face of the substrate, the colored layer typically has an overall thickness (per face) of suitably 0.1 μm or greater, preferably 0.5 μm or greater, or more preferably 0.7 μm or greater. The overall colored layer thickness (per face) can be about 0.8 μm or greater, or even 1 μm or greater. In some embodiments, in view of obtaining sufficient light-blocking properties and concealability, the overall colored layer thickness (per face) can be 2 μm or greater (e.g., 3 μm or greater), or even 4 μm or greater. The overall colored layer thickness (per face) is typically suitably 10 μm or less, preferably 7 μm or less, or more preferably 5 μm or less. In some embodiments, the overall colored layer thickness (per face) can be about 3 μm or less, or even about 2 μm or less.

### (Additional Layers)

The substrate may have an additional layer besides the substrate film and the colored layer (e.g., a black-colored layer). For instance, to obtain interlayer bonding strength, interlayer bonding layer, primer layer and the like can be formed. Alternatively, the art disclosed herein can be preferably implemented in an embodiment using a substrate free of other layers besides the substrate film and the colored layer.

While no particular limitations are imposed, in the PSA sheet disclosed herein, the total layer thickness excluding the PSA layer (i.e., the total non-adhesive layer thickness, typically the total substrate thickness, e.g., the combined thickness of the substrate film and the colored layer) is, for instance, about 200 μm or less, possibly about 100 μm or less, 70 μm or less, or 50 μm or less. By reducing the non-adhesive layer thickness, the PSA sheet can also be made thinner. This can also be advantageous in terms of making the products to which the PSA sheet is applied thinner, smaller, lighter, and resource-saving. In an embodiment where the PSA sheet is limited to a specific total thickness or less, the non-adhesive layer thickness can be limited as described above to increase the thickness ratio of the PSA layer and obtain superior adhesive properties. The minimum total non-adhesive layer thickness is not particularly limited. In view of ease of handling, processing, etc., it is typically suitably 2 μm or greater, or preferably 3 μm or greater (e.g., 3.5 μm or greater). In view of light-blocking properties and handling properties, the non-adhesive layer according to other embodiments may have a total thickness of 5 μm or greater, 12 μm or greater, 16 μm or greater, 20 μm or greater, or even 25 μm or greater. In some preferable embodiments, the non-adhesive layer thickness is, for instance, 1 μm or greater and 100 μm or less, more preferably 10 μm or greater and 80 μm or less, or particularly preferably 25 μm or greater and 75 μm or less.

### <PSA Layer>

### (Water-Dispersed PSA Composition)

The PSA layer disclosed herein is formed from a water-dispersed PSA composition. The water-dispersed PSA composition is a water dispersion (typically an aqueous emulsion) in which adhesive components are dispersed in an aqueous medium. As used herein, the term “aqueous medium” refers to a medium wherein the solvent making up the medium is water or a solvent mixture (aqueous solvent) comprising water as the primary component.

### (Acrylic Polymer)

The PSA composition disclosed herein is an acrylic PSA composition comprising an acrylic polymer as a base polymer. Herein, the term “base polymer” refers to the primary component among polymers in the PSA composition (which can be a PSA). In this description, the term “primary component” refers to a component that accounts for more than 50% by weight unless otherwise specified. In a preferable embodiment, the acrylic PSA composition is an emulsion acrylic PSA composition comprising a water-dispersed acrylic polymer. The water-dispersed acrylic polymer has an emulsion form where the acrylic polymer is dispersed in water. As for the acrylic polymer, it is preferable to use a polymer formed from an alkyl (meth)acrylate as the primary monomer (i.e. a component accounting for higher than 50% by weight of the total amount of the monomers constituting the acrylic polymer).

As the acrylic polymer, for example, a polymer of a monomeric starting material (monomers) comprising an alkyl (meth)acrylate as the primary monomer and possibly comprising a secondary monomer copolymerizable with the primary monomer is preferable. The primary monomer herein refers to a component that accounts for higher than 50% by weight of the monomer composition in the monomeric starting material.

As the alkyl (meth)acrylate, for instance, a compound represented by the following formula (1) can be preferably used:

CH₂═C(R¹)COOR² (1)

Herein, R¹ in the formula (1) is a hydrogen atom or a methyl group. R² is a linear alkyl group having 1 to 20 carbon atoms (hereinafter, such a range of the number of carbon atoms may be indicated as “C₁₋₂₀”). From the standpoint of the storage elastic modulus of PSA, an alkyl (meth)acrylate with R² being a C₁₋₁₄ linear alkyl group is preferable, an alkyl (meth)acrylate with R² being a C₁₋₁₀ linear alkyl group is more preferable, and an alkyl (meth)acrylate with R² being a butyl group or a 2-ethylhexyl group is particularly preferable.

Examples of an alkyl (meth)acrylate with R² being a C₁₋₂₀ linear alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate, etc. Among these alkyl (meth)acrylates, can be used one species solely or a combination of two or more species. Preferable alkyl (meth)acrylates include n-butyl acrylate (BA) and 2-ethylhexyl acrylate (2EHA).

The art disclosed herein can be preferably implemented in an embodiment where the monomers comprise an alkyl (meth)acrylate wherein R² in the formula (1) is a C₄₋₁₀ acyclic alkyl group (typically at least either BA or 2EHA) and the total amount of the alkyl (meth)acrylate having the C₄₋₁₀ acyclic alkyl group for R² in the formula (1) (typically the total amount of BA and 2EHA) accounts for 70% by weight or more (typically 80% by weight or more) of the alkyl (meth)acrylate(s) in the monomers.

When the alkyl (meth)acrylate comprises an alkyl (meth)acrylate having an acyclic C₄₋₁₀ alkyl group as R² in the formula (1) (typically at least either BA or 2EHA), the total amount of the other alkyl (meth)acrylate(s) (alkyl (meth)acrylate(s) having an acyclic C_{<4} or C_{>10} alkyl group (alkyl group with fewer than four carbon atoms or more than ten carbon atoms) as R² in the formula (1)) is preferably about 30% by weight or less (e.g. 20% by weight or less, typically 15% by weight or less) of the monomers constituting the acrylic polymer. From the standpoint of obtaining the effects of the other alkyl (meth)acrylate(s), their total amount is preferably about 1% by weight or more (e.g. 5% by weight or more, typically 10% by weight or more) of the monomers. As the other alkyl (meth)acrylate, an alkyl (meth)acrylate having an acyclic C₁₋₃ alkyl group as R² in the formula (1) can be preferably used. Specific examples thereof include methyl acrylate (MA), methyl methacrylate (MMA) and ethyl acrylate (EA). Among them, MA is more preferable.

The secondary monomer copolymerizable with the alkyl (meth)acrylate being the primary monomer may be useful for introducing crosslinking points in the acrylic polymer or increasing the cohesive strength of the acrylic polymer. As the secondary monomer, for instance, the following functional group-containing monomers can be used one species solely or a combination of two or more species:

Carboxy group-containing monomers: for example, ethylenic unsaturated mono-carboxylic acids such as acrylic acid (AA), methacrylic acid (MAA), crotonic acid, etc.; ethylenic unsaturated dicarboxylic acids such as maleic acid, itaconic acid, citraconic acid, etc., as well as anhydrides thereof (maleic acid anhydride, itaconic acid anhydride, etc.).

Hydroxy group-containing monomers: for example, hydroxyalkyl (meth)acrylates such as 2-hydroxyethyl (meth)acrylate, 2-hydroxypropyl (meth)acrylate, 3-hydroxypropyl (meth)acrylate, 4-hydroxybutyl (meth)acrylate, etc.; unsaturated alcohols such as vinyl alcohol, allyl alcohol, etc.

Amide group-containing monomers: for example, (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, N-butoxymethyl (meth)acrylamide.

Amino group-containing monomers: for example, aminoethyl (meth)acrylate, N,N-dimethylaminoethyl (meth)acrylate, t-butylaminoethyl (meth)acrylate.

Epoxy group-containing monomers: for example, glycidyl (meth)acrylate, methylglycidyl (meth)acrylate, allyl glycidyl ether.

Cyano group-containing monomers: for example, acrylonitrile, methacrylonitrile.

Keto group-containing monomers: for example, diacetone (meth)acrylamide, diacetone (meth)acrylate, vinyl methyl ketone, vinyl ethyl ketone, allyl acetoacetate, vinyl acetoacetate.

Monomers having nitrogen atom-containing rings: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, N-(meth)acryloyl morpholine.

The functional group-containing monomers can be used singly as one species or in a combination of two or more species. Among the functional group-containing monomers, for the abilities to preferably bring about introduction of crosslinking points as described above and an increase in cohesive strength, carboxy group-containing monomers and hydroxy group-containing monomers are preferable, with carboxy group-containing monomers being more preferable. Among carboxy group-containing monomers, AA and MAA are preferable.

In a preferable embodiment, as the functional group-containing monomer, AA and MAA are used together. The PSA composition comprising an acrylic polymer having such a monomer composition (i.e. copolymer composition) may produce a PSA sheet of higher performance (e.g. with greater repulsion resistance). The weight ratio of AA to MAA (AA/MAA) can be, for instance, in a range of 0.1 to 10. It is more preferably about 0.3 or higher (typically 0.5 or higher). It is more preferably about 4 or lower (typically 3 or lower). When AA/MAA is within these ranges, a sufficient effect to increase the repulsion resistance tends to be likely obtained and also after the PSA sheet is fabricated, it tends to have excellent temporal stability with respect to the adhesive properties.

When a functional group-containing monomer is copolymerized in the acrylic polymer, the ratio of functional group-containing monomer to all monomers constituting the acrylic polymer is not particularly limited. Usually, from the standpoint of combining cohesive strength and adhesiveness at a good balance, the ratio of functional group-containing monomer is preferably about 0.1 by weight or higher (e.g. 0.5% by weight or higher, typically 1% by weight or higher). In view of the effect of the alkyl (meth)acrylate on the adhesion, the ratio is preferably about 40% by weight or lower (e.g. 30% by weight or lower, typically 20% by weight or lower).

When a carboxy group-containing monomer is copolymerized in the acrylic polymer, the ratio of carboxy group-containing monomers to all monomers is suitably 15% by weight or lower from the standpoint of increasing the water resistance. It can be, for instance, 10% by weight or lower, 5% by weight or lower, or even 3% by weight or lower. On the other hand, from the standpoint of the cohesion, etc., in some embodiments, it can be, for instance, 0.1% by weight or higher, or even 0.5% by weight or higher. The art disclosed herein can bring about good water resistance even in an embodiment where the ratio of carboxyl group-containing monomers to all monomers is 1% by weight or higher, or an embodiment where it is 1.5% by weight or higher.

In some embodiments, a silanol-forming monomer is preferably copolymerized in the acrylic polymer. That is, in some preferable embodiments, the monomers forming the acrylic polymer includes a silanol-forming monomer. The silanol-forming monomer may have at least one functional group capable of introducing a crosslinked structure through silanol condensation (condensation reaction of silanol groups) into the PSA (PSA layer) formed from the PSA composition. The silanol-forming monomer can also be thought as a crosslinking agent (silane coupling agent). Favorable examples of the silanol-forming monomer include a silanol-forming monomer having at least one (preferably two or more, e.g., two or three) alkoxysilyl group(s) per molecule (i.e., an alkoxysilyl group-containing monomer). In view of copolymerizability with alkyl (meth)acrylate, a silanol-forming monomer whose one molecule has one, two or more ethylenic unsaturated groups such as acryloyl groups, methacryloyl groups (or “(meth)acryloyl groups” combining acryloyl groups and methacryloyl groups) and vinyl groups is preferable. A particularly preferable silanol-forming monomer has a (meth)acryloyl group and an alkoxysilyl group (e.g., one (meth)acryloyl group and two or three alkoxysilyl groups) per molecule.

Specific examples of the silanol-forming monomer include 3-methacryloxypropyltrimethoxysilane, 3-acryloxypropyltrimethoxysilane, 3-methacryloxypropyltriethoxysilane, 3-acryloxypropyltriethoxysilane, 3-methacryloxypropylmethyldimethoxysilane, 3-acryloxypropylmethyldimethoxysilane, 3-methacryloxypropylmethyldiethoxysilane, and 3-acryloxypropylmethyldiethoxysilane. Besides the above, other silanol-forming monomers include vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloxydecyltrimethoxysilane, 10-acryloxydecyltrimethoxysilane, 10-methacryloxydecyltriethoxysilane, and 10-acryloxydecyltriethoxysilane. An especially preferable example of the silanol-forming monomer is 3-methacryloxypropyltrimethoxysilane.

In some embodiments, the acrylic polymer disclosed herein is crosslinked through condensation of silanol groups originating from silanol-forming monomers. In other words, in some embodiments, the acrylic polymer disclosed herein is crosslinked with a silane coupling agent. According to the art disclosed herein, the PSA layer is formed from a water-dispersed PSA composition. In the water-dispersed PSA composition, microparticles of adhesive components are dispersed in an aqueous medium; and therefore, when compared with solvent-based compositions, crosslink inhibitors in the colored layer of the substrate are less likely to migrate. In this way, the use of the water-dispersed PSA composition suppresses migration of crosslink inhibitors from the substrate to the PSA composition; and therefore, crosslinking inhibition is favorably suppressed even in the condensation reaction of silanol groups as described above. Accordingly, when an acrylic polymer crosslinked with silanol-forming monomers is used as the base polymer in the water-dispersed PSA composition, the resulting PSA sheet tends to be less susceptible to reduction of holding power caused by crosslinking inhibition.

When a silanol-forming monomer (e.g., alkoxysilyl group-containing monomer) is copolymerized in the acrylic polymer, the ratio of silanol-group-containing monomer (e.g., alkoxysilyl group-containing monomer) is suitably 0.005% by weight or higher (e.g. 0.01% by weight or higher) of all the monomers. This ratio is suitably about 0.1% by weight or lower (e.g. 0.03% by weight or lower).

For the purpose of increasing the cohesive strength of the acrylic polymer, etc., other co-monomer(s) besides the aforementioned secondary monomers can be used. Examples of such co-monomers include vinyl ester-based monomers such as vinyl acetate, vinyl propionate, etc.; aromatic vinyl compounds such as styrene, substituted styrenes (α-methylstyrene, etc.), vinyl toluene, etc.; cycloalkyl (meth)acrylates such as cyclohexyl (meth)acrylate, cyclopentyl (meth)acrylate, isobornyl (meth)acrylate, etc.; aromatic ring-containing (meth)acrylates such as aryl (meth)acrylate (e.g. phenyl (meth)acrylate), aryloxyalkyl (meth)acrylate (e.g. phenoxyethyl (meth)acrylate), arylalkyl (meth)acrylate (e.g. benzyl (meth)acrylate), etc.; olefinic monomers such as ethylene, propylene, isoprene, butadiene, isobutylene, etc.; chlorine-containing monomers such as vinyl chloride, vinylidene chloride, etc.; isocyanate group-containing monomers such as 2-(meth)acryloyloxyethyl isocyanate, etc.; alkoxy group-containing monomers such as methoxyethyl (meth)acrylate, ethoxyethyl (meth)acrylate, etc.; vinyl ether-based monomers such as methyl vinyl ether, ethyl vinyl ether, etc.; and the like.

Other examples of the other co-monomers excluding the secondary monomer include monomers having a plurality of functional groups in a molecule. Illustrative examples of such polyfunctional monomers include 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly) propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, glycerol di(meth)acrylate, epoxy acrylate, polyester acrylate, urethane acrylate, divinylbenzene, butyl di(meth)acrylate and hexyl di(meth)acrylate.

The amount of the other co-monomer(s) excluding the secondary monomer can be suitably selected according to the purpose and intended use, and thus is not particularly limited. For instance, it is preferable to be 10% by weight or less of the monomer composition of the acrylic polymer.

The acrylic polymer in the art disclosed herein is suitably designed to have a glass transition temperature (Tg) of −25° C. or below (typically −75° C. or above, but −25° C. or below). The acrylic polymer's Tg can be preferably −40° C. or below (e.g. −70° C. or above, but −40° C. or below) or more preferably −50° C. or below (typically −70° C. or above, but −50° C. or below). It is preferable that the acrylic polymer's Tg is at or below the upper limits from the standpoint of increasing the adhesive strength. The Tg of the acrylic polymer can be adjusted by the types and relative amounts of monomers used for synthesis of the polymer.

Herein, the Tg of an acrylic polymer refers to the value determined by the Fox equation based on the composition of the monomers. As shown below, the Fox equation is a relational expression between the Tg of a copolymer and glass transition temperatures Tgi of homopolymers of the respective monomers constituting the copolymer.

$$1 / Tg = \sum ( Wi / Tgi )$$

In the Fox equation, Tg represents the glass transition temperature (unit: K) of the copolymer, Wi represents the weight fraction (copolymerization ratio by weight) of a monomer i in the copolymer, and Tgi represents the glass transition temperature (unit: K) of homopolymer of the monomer i.

As the glass transition temperatures of homopolymers used for determining the Tg value, values found in publicly known documents are used. For example, with respect to the monomers listed below, as the glass transition temperatures of homopolymers of the monomers, the following values are used:
2-ethylhexyl acrylate −70° C.
n-butyl acrylate −55° C.
methyl methacrylate 105° C.
methyl acrylate 8° C.
vinyl acetate 32° C.
acrylic acid 106° C.
methacrylic acid 228° C.

With respect to the glass transition temperatures of homopolymers of monomers other than those listed above, values given in “Polymer Handbook” (3rd edition, John Wiley & Sons, Inc., Year 1989) are used. When the literature provides two or more values, the highest value is used.

With respect to monomers for whose homopolymers no glass transitions temperatures are given in Polymer Handbook, either, values obtained by the following measurement method are used (see Japanese Patent Application Publication No. 2007-51271). In particular, to a reaction vessel equipped with a thermometer, a stirrer, a nitrogen inlet and a condenser, are added 100 parts by weight of monomer, 0.2 part by weight of azobisisobutyronitrile, and 200 parts by weight of ethyl acetate as a polymerization solvent, and the mixture is stirred for one hour under a nitrogen gas flow. After oxygen is removed in this way from the polymerization system, the mixture is heated to 63° C. and the reaction is carried out for 10 hours. Then, it is cooled to room temperature, and a homopolymer solution having 33% by mass solids content is obtained. Then, this homopolymer solution is applied onto a release liner by flow coating and allowed to dry to prepare a test sample (a sheet of homopolymer) of about 2 mm thickness. This test sample is cut out into a disc of 7.9 mm diameter and is placed between parallel plates; and while applying a shear strain at a frequency of 1 Hz using a rheometer (ARES, available from Rheometrics Scientific, Inc.), the viscoelasticity is measured in the shear mode over a temperature range of −70° C. to 150° C. at a heating rate of 5° C./min; and the temperature value at the maximum of the tan & curve is taken as the Tg of the homopolymer.

The method for obtaining the acrylic polymer is not particularly limited. Various polymerization methods known as synthetic means for acrylic polymers can be suitably employed, such as a solution polymerization method, emulsion polymerization method, bulk polymerization method, suspension polymerization method, photopolymerization method, etc. As for preferable polymerization methods, the emulsion polymerization method is cited. The embodiment of emulsion polymerization is not particularly limited. Various monomer supply methods, polymerization conditions, materials and the like similar to those for heretofore known general emulsion polymerization can be suitably used to carry out polymerization. Examples of suitable monomer supply methods include an all-at-once supply method where all starting monomers are supplied at once, continuous (dropwise) supply method, portionwise (dropwise) supply method, etc. Starting monomers can be added dropwise as an aqueous emulsion. The polymerization temperature can be about 20° C. or higher (usually 40° C. or higher) while it is suitably about 100° C. or lower (usually 80° C. or lower).

According to the emulsion polymerization, a polymerization mixture can be prepared as an emulsion of acrylic polymer dispersed in water (acrylic polymer emulsion). The water-dispersed PSA composition disclosed herein may be preferably produced using the polymerization mixture or such a polymerization mixture upon suitable work-up. Alternatively, an acrylic polymer emulsion may be prepared by a polymerization method other than emulsion polymerization (e.g. solution polymerization, photopolymerization, bulk polymerization, etc.) to synthesize an acrylic polymer, then dispersing the polymer in water.

The initiator used for the polymerization can be suitably selected in accordance with the type of polymerization method among heretofore known polymerization initiators. Examples include, but not limited to, azo-based initiators such as 2,2′-azobisisobutyronitrile, 2,2′-azobis(2-methylpropionamidine) disulfate salt, 2,2′-azobis(2-methylpropionamidine) dihydrochloride salt, 2,2′-azobis(2-amidinopropane) dihydrochloride salt, 2,2′-azobis [N-(2-carboxyethyl)-2-methylpropionamidine]hydrate, 2,2′-azobis(N,N′-dimethylene isobutylamidine), 2,2′-azobis [2-(2-imidazolin-2-yl) propane]dihydrochloride salt, etc.; persulfate salt-based initiators such as potassium persulfate, ammonium persulfate, etc.; peroxide-based initiators such as benzoyl peroxide, t-butyl hydroperoxide, hydrogen peroxide, etc.; substituted ethane-based initiators such as phenyl-substituted ethane, etc.; carbonyl-based initiators such as aromatic carbonyl compounds, etc.; redox-based initiators such as a combination of a persulfate salt and sodium hydrogen sulfite, a combination of a peroxide and sodium ascorbate, etc.; and so on. These polymerization initiators can be used singly as one species or in a combination of two or more species.

The polymerization initiator can be used in a usual amount and is not particularly limited. For instance, it can be selected from a range of about 0.005 by weight or above (preferably 0.01 part by weight or above) and of 1 part by weight or below (preferably 0.8 part by weight or below) relative to 100 parts by weight of all monomers.

In the polymerization, a chain transfer agent (which may also be thought as a molecular weight modifier or a regulator of polymerization degree) may be used as necessary. Examples of the chain transfer agent include mercaptans such as dodecyl mercaptan (dodecanethiol), lauryl mercaptan, glycidyl mercaptan, 2-mercaptoethanol, mercaptoacetic acid, 2-ethylhexyl thioglycolate and 2,3-dimethylcapto-1-propanol; α-methyl styrene dimer; and the like. Such chain transfer agents may be used singly or as a combination of two or more species.

To 100 parts by weight of the monomers, the chain transfer agent can be used in an amount of about 0.001 part by weight or greater (typically about 0.005 part by weight or greater), and, for instance, about 5 parts by weight or less (typically about 2 parts by weight or less, e.g. about 1 part by weight or less). By using a suitable amount of the chain transfer agent, a desirable conversion to polymer can be obtained.

Emulsion polymerization of the starting monomers is typically carried out in the presence of a surfactant (emulsifier). The amount of surfactant used is not particularly limited. In view of the polymerization stability and dispersion stability of the polymerization reactants, the amount of surfactant used is typically suitably 0.1 part by weight or greater, or preferably 0.5 part by weight or greater relative to 100 parts by weight of the starting monomers. From the standpoint of obtaining higher stability, it can be 1.0 part by weight or greater, or even 1.5 parts by weight or greater. The surfactant can be used in an amount of, for instance, 10 parts by weight or less relative to 100 parts by weight of the starting monomers. On the other hand, from the standpoint of increasing the water resistance, it is desirable to reduce the usage of surfactant (especially non-reactive surfactant). From such a standpoint, the amount of surfactant used is typically preferably 5 parts by weight or less, possibly 4 parts by weight or less, 3 parts by weight or less, or even 2.5 parts by weight or less.

As the surfactant, commonly known anionic surfactants, nonionic surfactants, cationic surfactants and the like can be used. Typically, an anionic or nonionic surfactant is preferable. A surfactant having a reactive functional group (in typical, a radically-polymerizable functional group) can also be used. Hereinafter, a surfactant having a reactive functional group may be referred to as a reactive surfactant while a general surfactant free of a reactive functional group may be referred to as a non-reactive surfactant. For the surfactant, solely one species or a combination of two or more species can be used.

Examples of non-reactive anionic surfactants include alkyl sulfates such as lauryl sulfate and octadecyl sulfate; fatty acid salts; alkyl benzene sulfonates such as nonyl benzene sulfonate and dodecyl benzene sulfonate; naphthalene sulfonates such as dodecylnaphthalene sulfonate; alkyl diphenyl ether disulfonate such as dodecyl diphenyl ether disulfonate; polyoxyethylene alkyl ether sulfates such as polyoxyethylene octadecyl ether sulfate and polyoxyethylene lauryl ether sulfate; polyoxyethylene alkyl phenyl ether sulfates such as polyoxyethylene lauryl phenyl ether sulfate; polyoxyethylene styrenated phenyl ether sulfate; sulfosuccinates such as lauryl sulfosuccinate and polyoxyethylene lauryl sulfosuccinate; polyoxyethylene alkyl ether phosphates; and polyoxyethylene alkyl ether acetates. When the anionic surfactant is in a salt form, the salt can be, for instance, a metal salt (preferably a monovalent metal salt) such as a sodium salt, potassium salt, calcium salt and magnesium salt; ammonium salt; or amine salt.

Examples of non-reactive nonionic surfactants include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan fatty acid esters such as sorbitan monolaurate, sorbitan monostearate and polyoxyethylene sorbitan monolaurate; polyoxyethylene glyceryl ether fatty acid esters; and polyoxyethylene-polyoxypropylene block copolymers.

As the reactive surfactant, it is preferable to use a species having a polymerizable (in typical, radically-polymerizable) functional group. For instance, it is possible to use a reactive surfactant having a structure of an aforementioned anionic or nonionic surfactant with an introduced radically-polymerizable functional group. The type of radically-polymerizable functional group is not particularly limited. It can be, for instance, an alkenyl group, acryloyl group, methacryloyl group, vinyl group, vinyl ether group (vinyloxy group), allyl ether group (allyloxy group), etc. Specific examples of the alkenyl group include propenyl group and isopropenyl group (CH₂═C(CH₃)—). The concept of propenyl group referred to herein encompasses 1-propenyl group (CH₃—CH═CH—) and 2-propenyl group (CH₂═CH—CH₂— which may be called allyl group).

Examples of anionic reactive surfactants include polyoxyethylene (allyloxymethyl) alkyl ether sulfates (e.g. ammonium salts), polyoxyethylene nonyl propenyl phenyl ether sulfates (e.g. ammonium salts), alkyl allyl sulfosuccinates (e.g. sodium salts), methacryloxy polyoxypropylene sulfuric acid ester salts (e.g. sodium salts), and polyoxyalkylene alkenyl ether sulfates (e.g. an ammonium salt having an isopropenyl group as the terminal alkenyl group). When the anionic reactive surfactant is forming a salt, the salt can be, for instance, a metal salt such as sodium salt or a non-metal salt such as ammonium salt and amine salt.

An example of nonionic reactive surfactants is polyoxyethylene nonyl propenyl phenyl ether.

Commercially available reactive surfactants include trade names AQUALON HS-05, AQUALON HS-10, AQUALON HS-1025, AQUALON HS-20, AQUALON KH-10, AQUALON KH-1025, AQUALON KH-05, AQUALON BC-0515, AQUALON BC-10, AQUALON BC-1025, AQUALON BC-20, AQUALON BC-2020, AQUALON RN-20, AQUALON RN-30, AQUALON RN-50, AQUALON AR-10, AQUALON AR-20 AQUALON AR-1025 and AQUALON AR-2020 available from DKS Co., Ltd.; trade names ADEKA REASOAP SE-10N and ADEKA REASOAP SR-1025 available from ADEKA Corporation; trade names LATEMULE PD-104, LATEMULE PD-420, LATEMULE PD-430 and LATEMULE PD-450 available from Kao Corporation; trade names ELEMINOL JS-20 and ELEMINOL RS-3000 available from Sanyo Chemical Industries, Ltd; and trade name ANTOX MS-60 available from Nippon Nyukazai Co., Ltd.

From the standpoint of the emulsification properties, etc., in an embodiment, an anionic reactive surfactant can be preferably used.

When using a nonionic reactive surfactant, more favorable results can be obtained when used in combination with other surfactant(s), for instance, an anionic reactive surfactant, anionic non-reactive surfactant, nonionic non-reactive surfactant, etc.

From the standpoint of increasing the water resistance, the surfactant used in the art disclosed herein preferably comprises a reactive surfactant. In other words, at least one of the surfactants used is preferably a reactive surfactant. By carrying out emulsion polymerization of the starting monomers in the presence of a reactive surfactant, the reactive surfactant may undergo a reaction to be incorporated in the acrylic polymer. Upon incorporation in the acrylic polymer, the surfactant in its free form will decrease in amount. This can increase the water resistance. Thus, when carrying out the polymerization, the use of reactive surfactant can be advantageous for combining polymerization stability and water resistance of the PSA layer obtained from the post-polymerization, acrylic polymer-containing PSA composition. From the standpoint of obtaining superior water resistance, the ratio of reactive surfactant in the total weight of surfactant used in the emulsion polymerization can be 50% by weight or higher, or more preferably 70% by weight or higher. For instance, it may be preferable to employ an embodiment using solely a reactive surfactant as the surfactant. The reactive surfactant incorporated in the acrylic polymer is unlikely to bleed out to the PSA layer surface because its movement is limited in the PSA layer. This may also preferably help increase the water resistance. It is noted that, in this Description, the concept of including a reactive surfactant encompasses including the reactive surfactant with its reactive functional group (e.g. radically-polymerizable functional group) in a reacted form. Of the reactive surfactant in the art disclosed herein, at least some molecules are typically incorporated in the acrylic polymer as described above when included in a water-dispersed PSA composition or a PSA layer.

The weight average molecular weight (Mw) of the acrylic polymer is not particularly limited. For instance, it can be in a range of 10×10⁴ to 500×10⁴. Herein the Mw of the acrylic polymer refers to a Mw of a toluene-soluble material (a sol component) of the acrylic polymer. The Mw of the acrylic polymer refers to the value based on standard polystyrene determined by GPC (gel permeation chromatography). From the standpoint of increasing the adhesive properties, the acrylic polymer may have a Mw of preferably 150×10⁴ or smaller, or more preferably 100×10⁴ or smaller. From the standpoint of the cohesion, etc., the acrylic polymer may have a Mw of preferably 20×10⁴ or larger, or more preferably 30×10⁴ or larger (e.g. 40×10⁴ or larger).

### (Crosslinking Agent)

The water-dispersed PSA composition used for forming the PSA layer preferably comprises a crosslinking agent as an optional component. The PSA layer in the art disclosed herein may comprise the crosslinking agent in a post-crosslinking-reaction form, in a pre-crosslinking-reaction form, in a partially crosslinked form, in an intermediate or combined form of these, etc. In typical, the crosslinking agent is included in the PSA layer mostly in the post-crosslinking-reaction form.

Specific examples of the crosslinking agent include oxazoline-based crosslinking agents, aziridine-based crosslinking agents, isocyanate-based crosslinking agents, epoxy-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, hydrazine-based crosslinking agents, amine-based crosslinking agents, and silane coupling agents. These can be used solely as one species or in a combination of two or more species.

Among them, favorable examples of the crosslinking agent used in the art disclosed herein include an oxazoline-based crosslinking agent, carbodiimide-based crosslinking agent, epoxy-based crosslinking agent and isocyanate-based crosslinking agent. Among these, solely one species or a combination of two or more species can be used. According to the art disclosed herein, because the PSA layer is formed from a water-dispersed PSA composition, crosslink inhibitors are less likely to migrate from the substrate to the PSA composition. This leads to favorable suppression of crosslinking inhibition in crosslinking reaction using a crosslinking agent as described above. Accordingly, when an acrylic polymer crosslinked with the crosslinking agent is used as the acrylic polymer in the water-dispersed PSA composition, reduction of holding power caused by crosslinking inhibition is less likely to occur in the resulting PSA sheet.

As the oxazoline-based crosslinking agent, a species having one or more oxazoline groups per molecule can be used without particular limitations. For the oxazoline-based crosslinking agent, solely one species or a combination of two or more species can be used. For use in the water-dispersed PSA composition, a water-soluble or water-dispersible oxazoline-based crosslinking agent is preferable.

The oxazoline group can be either 2-oxazoling group, 3-oxazoline group or 4-oxazoline group. Usually, a 2-oxazoline group-containing oxazoline-based crosslinking agent can be preferably used. As the oxazoline-based crosslinking agent, a water-soluble copolymer or a water-dispersed copolymer can be used, which is obtained by copolymerizing an addition-polymerizable oxazoline such as 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline and 2-isopropenyl-5-ethyl-2-oxazoline with other monomer(s). Examples of a commercial oxazoline-based crosslinking agent include product names EPOCROS WS-500, EPOCROS WS-700, EPOCROS K-2010E, EPOCROS K-2020E and EPOCROS K-2030E available from Nippon Shokubai Co., Ltd.

As the carbodiimide-based crosslinking agent, a lower or higher molecular weight compound having two or more carbodiimide groups can be used. In a water-dispersed PSA composition, it is preferable to use a water-soluble or water-dispersible carbodiimide-based crosslinking agent. Examples of commercial carbodiimide-based crosslinking agents include the CARBODILITE series such as the CARBODILITE V series (aqueous solutions) including CARBODILITE V-02, CARBODILITE V-02-L2, and CARBODILITE V-04; and the CARBODILITE E series (aqueous dispersions) including CARBODILITE E-01, CARBODILITE E-02, and CARBODILITE E-04 available from Nisshinbo Holdings, Inc.

As the epoxy-based crosslinking agent, a species having two or more epoxy groups per molecule can be used without particular limitations. An epoxy-based crosslinking agent having 3 to 5 epoxy groups per molecule is preferable. For the epoxy-based crosslinking agent, solely one species or a combination of two or more species can be used. A water-soluble or water-dispersible epoxy-based crosslinking agent is preferable.

Specific examples of the epoxy-based crosslinking agent include N,N,N′,N′-tetraglycidyl-m-xylenediamine, 1,3-bis(N,N-diglycidylaminomethyl) cyclohexane, 1,6-hexanediol diglycidyl ether, polyethylene glycol diglycidyl ether, and polyglycerol polyglycidyl ether.

Commercial epoxy-based crosslinking agents include product names TETRAD-X and TETRAD-C available from Mitsubishi Gas Chemical Co., Inc.; product name EPICLON CR-5L available from DIC Corporation; product name DENACOL EX-512 available from Nagase ChemteX Corporation; and product name TEPIC-G available from Nissan Chemical Industries, Ltd.

As the isocyanate-based crosslinking agent, a species having two or more isocyanate groups per molecule can be used without particular limitations. The isocyanate groups in the isocyanate-based crosslinking agent may have protecting groups, for instance, forming isocyanate-forming functional groups (blocked isocyanates) in an embodiment where the isocyanate groups are temporarily protected via blocking agent treatment, etc. For the isocyanate-based crosslinking agent, solely one species or a combination of two or more species can be used.

Examples of the isocyanate-based crosslinking agent include aromatic polyisocyanates such as tolylene diisocyanates and xylylene diisocyanate; aliphatic isocyanates such as isophorone diisocyanate; and alicyclic polyisocyanates such as hexamethylene diisocyanate.

More specific examples include lower aliphatic polyisocyanates such as butylene diisocyanate and hexamethylene diisocyanate; alicyclic polyisocyanates such as cyclopentylene diisocyanate, cyclohexylene diisocyanate and isophorone diisocyanate; aromatic diisocyanates such as 2,4-tolylene diisocyanate, 4,4′-diphenylmethane diisocyanate, xylylene diisocyanate and polymethylene polyphenyl diisocyanate; isocyanate adducts such as trimethylolpropane-tolylene diisocyanate trimer adduct (product name CORONATE L available from Tosoh Corporation, etc.), trimethylolpropane-hexamethylene diisocyanate trimer adduct (product name CORONATE HL available from Tosoh Corporation, etc.), and isocyanurate of hexamethylene diisocyanate (product name CORONATE HX available from Tosoh Corporation, etc.); polyisocyanates such as polyether polyisocyanate and polyester polyisocyanate; adducts of these polyisocyanates and polyols; and polyfunctionalization products of these polyisocyanates with isocyanurate bonds, biuret bonds, allophanate bonds, etc.

For use in the water-dispersed PSA composition, a water-soluble or water-dispersible isocyanate-based crosslinking agent is preferable. For instance, it is preferable to use a water-soluble, water-dispersible, or self-emulsifying isocyanate-based crosslinking agent. Commercially-available examples of such isocyanate-based crosslinking agents (aqueous isocyanate-based crosslinking agents) include BURNOCK DNW-5000, BURNOCK DNW-5010, BURNOCK DNW-5100, BURNOCK DNW-5200, BURNOCK DNW-5500 and BURNOCK DNW-6000 available from DIC Corporation; AQUANATE 100, AQUANATE 105, AQUANATE 110, AQUANATE 120, AQUANATE 130, AQUANATE 200 and AQUANATE 210 available from Tosoh Corporation; TAKENATE WD-220, TAKENATE WD-240, TAKENATE WD-720, TAKENATE WD-725, TAKENATE WD-726, TAKENATE WD-730, TAKENATE WB-700, TAKENATE WB-720 and TAKENATE WB-920 available from Mitsui Chemicals & SKC Polyurethanes Inc.; and ELASTRON BN-04, ELASTRON BN-11, ELASTRON BN-27, ELASTRON BN-69 and ELASTRON BN-77 available from DKS Co., Ltd.

The crosslinking agent content (the total amount of crosslinking agent) in the PSA composition disclosed herein is not particularly limited and can be suitably selected in view of the composition and the molecular weight of the base polymer to obtain favorable properties after crosslinked. While no particular limitations are imposed, the amount of the crosslinking agent used to 100 parts by weight of the base polymer (typically an acrylic polymer) is about 0.01 part by weight or greater, suitably about 0.1 part by weight or greater, or preferably about 1 part by weight or greater (e.g. about 2 parts by weight or greater). From the standpoint of the adhesion, etc., the amount of the crosslinking agent is suitably about 15 parts by weight or less (preferably about 10 parts by weight or less, e.g. about 5 parts by weight or less) to 100 parts by weight of the base polymer. From the standpoint of increasing the tightness of adhesion to adherends, it is preferably about 4 parts by weight or less, more preferably less than 3.5 parts by weight, or yet more preferably less than 3 parts by weight.

### (Tackifier Resin)

The water-dispersed PSA composition disclosed herein can comprise a tackifier resin. The use of tackifier resin helps obtain a PSA sheet having excellent adhesive properties (e.g. adhesive strength, repulsion resistance). The tackifier resin can be a water-dispersed tackifier resin (also called tackifier resin emulsion). For instance, by mixing an aqueous emulsion of an acrylic polymer and an emulsion of the tackifier resin, a PSA composition can be easily prepared, comprising these components at a desirable ratio. A preferable tackifier resin emulsion is essentially free of at least aromatic hydrocarbon-based solvents (more preferably essentially free of aromatic hydrocarbon-based solvents and other organic solvents).

Examples of the tackifier resin include rosin-based tackifier resins (including rosin derivative tackifier resins), petroleum-based tackifier resins, terpene-based tackifier resins, phenolic tackifier resins and ketone-based tackifier resins. These can be used solely as one species or in a combination of two or more species.

Examples of the rosin-based tackifier resin include rosins such as gum rosin, wood rosin and tall oil rosin as well as stabilized rosins (e.g. stabilized rosins obtained by disproportionation or hydrogenation of the rosins), polymerized rosins (e.g. multimers, typically dimers, of the rosins) and modified rosins (e.g. unsaturated acid-modified rosins obtained by modification with an unsaturated acid such as maleic acid, fumaric acid or (meth)acrylic acid).

Examples of the rosin derivative tackifier resin include esterification products of the rosin-based resins (e.g. rosin esters such as stabilized rosin esters and polymerized rosin esters), phenol modification products of the rosin-based resins (phenol-modified rosins) and their esterification products (phenol-modified rosin esters).

Examples of the petroleum-based tackifier resin include aliphatic petroleum resins, aromatic petroleum resins, copolymeric petroleum resins, alicyclic petroleum resins and their hydrogenation products.

Examples of the terpene-based tackifier resin include α-pinene resins, β-pinene resins, aromatic group-modified terpene-based resins, and terpene-phenolic resins.

Examples of the ketone-based tackifier resin include ketone-based resins resulting from condensation of ketones (e.g. aliphatic ketones such as methyl ethyl ketone, methyl isobutyl ketone, acetophenone, etc.; alicyclic ketones such as cyclohexanone, methyl cyclohexanone, etc.) with formaldehyde.

Examples of the tackifier resin that can be preferably used in the art disclosed herein include rosin-based tackifier resins and terpene-based tackifier resins. Preferable examples of rosin-based tackifier resins include stabilized rosin esters and polymerized rosin esters. Preferable examples of terpene-based tackifier resins include terpene-phenol-based resins.

Such a tackifier resin emulsion can be prepared, using a surfactant (emulsifier) as necessary. As the surfactant possibly used in preparation of the tackifier resin emulsion, one, two or more species can be suitably selected and used among the same kinds of surfactant usable in preparation of the acrylic polymer emulsion. In typical, an anionic surfactant or nonionic surfactant is preferably used. The surfactant used for preparing the tackifier resin emulsion can be the same as or different from the surfactant used for preparing the acrylic polymer emulsion. For instance, it is preferable to employ an embodiment using an anionic surfactant in each emulsion preparation, an embodiment using a nonionic surfactant in each emulsion preparation, an embodiment using an anionic surfactant in one and a nonionic surfactant in the other, etc. The amount of surfactant used is not particularly limited as long as the tackifier resin can be prepared as an emulsion. For instance, it can be about 0.2 part by weight or greater (preferably 0.5 part by weight or greater) and about 10 parts by weight or less (preferably 5 parts by weight or less) to 100 parts by weight of tackifier resin (non-volatiles).

The softening point (Ts) of the tackifier resin used is not particularly limited. From the standpoint of enhancing the cohesion, etc., the tackifier resin's Ts is, for instance, possibly 80° C. or higher, preferably 90° C. or higher, also possibly 100° C. or higher, 120° C. or higher, or even 130° C. or higher.

While no particular limitations are imposed, in some embodiments, the tackifier resin in the art disclosed herein may comprise a high-Ts tackifier resin having a Ts of 140° C. or higher. The high-Ts tackifier resin has a Ts of preferably 145° C. or higher, for instance, possibly 150° C. or higher. The use of high-Ts tackifier resin can favorably combine adhesion and cohesion. The maximum Ts of the tackifier resin is not particularly limited. From the standpoint of the compatibility, low-temperature properties, etc., it is usually suitably 200° C. or lower, preferably 180° C. or lower, or possibly 175° C. or lower.

The softening point of a tackifier resin as referred to herein is defined as a value measured based on the softening point test method (ring and ball method) specified in both JIS K5902 and JIS K2207. In particular, a sample is quickly melted at a lowest possible temperature, and with caution to avoid bubble formation, the melted sample is poured into a ring to the top, with the ring being placed on top of a flat metal plate. After cooled, any portion of the sample risen above the plane including the upper rim of the ring is sliced off with a small knife that has been somewhat heated. Following this, a support (ring support) is placed in a glass container (heating bath) having a diameter of 85 mm or larger and a height of 127 mm or larger, and glycerin is poured into this to a depth of 90 mm or deeper. Then, a steel ball (9.5 mm diameter, weighing 3.5 g) and the ring filled with the sample are immersed in the glycerin while preventing them from making contact. The temperature of glycerin is maintained at 20° C.±5° C. for 15 minutes. The steel ball is then placed at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated evenly by projecting a Bunsen burner flame at the midpoint between the center and the rim of the bottom of the container. After the temperature has reached 40° C. from the start of heating, the rate of the bath temperature rise must be kept at 5.0° C.±0.5° C. per minute. As the sample gradually softens, the temperature at which the sample flows out of the ring and finally touches the bottom plate is read as the softening point. Two or more measurements of softening point are performed at the same time, and their average value is used.

From the standpoint of obtaining preferable effects of the use, usually, the amount (based on non-volatiles) of tackifier resin used is, to 100 parts by weight of base polymer (typically an acrylic polymer), suitably 1 part by weight or greater, preferably 3 parts by weight or greater (e.g. 5 parts by weight or greater), more preferably 12 parts by weight or greater, or yet more preferably 16 parts by weight or greater. According to the art disclosed herein, good water resistance can be obtained even in an embodiment comprising 22 parts or more (e.g. 25 parts or more) by weight of tackifier resin to 100 parts by weight of base polymer. From the standpoint of the cohesive strength, etc., usually, the amount of tackifier resin used is, to 100 parts by weight of base polymer, suitably 90 parts by weight or less, preferably 70 parts by weight or less, more preferably 55 parts by weight or less, yet more preferably 50 parts by weight or less (e.g. 45 parts by weight or less, typically 40 parts by weight or less).

When the water-dispersed PSA composition disclosed herein comprises a high-Ts tackifier resin, from the standpoint of the cohesive strength, etc., the high-Ts tackifier resin can be used alone as the tackifier resin. From the standpoint of balancing with various other adhesive properties, in some embodiments, a high-Ts tackifier resin can be used in combination with a tackifier resin having a lower Ts (e.g. a tackifier resin with Ts≤120° C. or Ts≤110° C.). In such an embodiment, the ratio of high-Ts tackifier resin in the entire tackifier resin used can be, for instance, 20% by weight or higher, 40% by weight or higher, or even 60% by weight or higher. The ratio of high-Ts tackifier resin can be, for instance, 90% by weight or lower, 80% by weight or lower, or even 70% by weight or lower.

### (Polyacrylic Acid)

In some embodiments, the water-dispersed PSA composition may include a polyacrylic acid. The polyacrylic acid may serve as a thickener. The inclusion of polyacrylic acid in the water-dispersed PSA composition can increase the polarity of the PSA layer formed from the water-dispersed PSA composition to effectively improve the adhesive properties such as metal adhesion. The use of polyacrylic acid tends to improve water resistance as well.

In some embodiments, the polyacrylic acid has a weight average molecular weight (Mw) of 5×10⁴ or higher, preferably 10×10⁴ or higher, or more preferably 15×10⁴ or higher. In some embodiments, the polyacrylic acid has a Mw or 30×10⁴ or lower, or preferably 25×10⁴ or lower. The polyacrylic acid's Mw refers to a value based on standard polyethylene glycol/polyethylene oxide by GPC.

In some embodiments, the amount of polyacrylic acid used per 100 parts by weight of base polymer (typically, an acrylic polymer) is possibly 1.0 part by weight or greater, preferably 1.5 parts by weight or greater, more preferably 3.0 parts by weight or greater, or also possibly 3.5 parts by weight or greater. An increase in amount of polyacrylic acid helps improve metal adhesion or increase water resistance. In some embodiments, the amount of acrylic acid used per 100 parts by weight of base polymer can be 10 parts by weight or less, 8.0 parts by weight or less, 6.0 parts by weight or less, 5.0 parts by weight or less, or even 4.0 parts by weight or less.

### (Leveling Agent)

In some embodiments, the water-dispersed PSA composition may include a leveling agent. The leveling agent-containing water-dispersed PSA composition can enhance the wetting properties of the water-dispersed PSA composition relative to the support substrate. With greater wetting properties, when a coating of the water-dispersed PSA composition is applied to form a PSA layer, the coating film of the composition will be less susceptible to beading. This will reduce the occurrence of cosmetic defects in the PSA layer and also in the PSA sheet. This also helps reduce the PSA layer thickness (e.g., to or below 30 μm in thickness).

The species of leveling agent is not particularly limited. Examples of the leveling agent include SURFYNOL 420 (acetylene glycol ethylene oxide-based surfactant, available from Nisshin Kagaku Kogyo K.K.), PELEX OT-P (sodium dialkyl sulfosuccinate available from Kao Corporation), NEOCOL P (sodium dialkyl sulfosuccinate available from DKS Co., Ltd.), NEOCOL SW—C(sodium dialkyl sulfosuccinate available from DKS Co., Ltd.), NOPCOWET 50 (sulfonic acid-based anionic surfactant available from San Nopco, Ltd.), SN-WET 126 (modified silicone/special polyether-based surfactant available from San Nopco, Ltd.), SN-WET FST2 (polyoxyalkyleneamine nonionic wetting agent available from San Nopco, Ltd.), SN-WET S (polyoxyalkyleneamine ether nonionic wetting agent available from San Nopco, Ltd.), and SN-WET 125 (modified silicone-based surfactant available from San Nopco, Ltd.). For the leveling agent, solely one species or a combination of two or more species can be used.

In some preferable embodiments, a sodium dialkyl sulfosuccinate can be used as the leveling agent. Such a leveling agent can further enhance the wetting properties of the water-dispersed PSA composition.

The number of carbons in the sodium dialkyl sulfosuccinate is not particularly limited. In some embodiments, it is 4 or higher, preferably 6 or higher, or more preferably 8 or higher. While no particular limitations are imposed on the number of carbons in the sodium dialkyl sulfosuccinate, in some embodiments, it is 20 or lower, preferably 12 or lower, or more preferably 10 or lower.

In some embodiments, the amount of leveling agent used per 100 parts by weight or base polymer (typically an acrylic polymer) is possibly 0.3 part by weight or greater, preferably 0.4 part by weight or greater, more preferably 0.5 part by weight or greater, or also possibly 0.7 part by weight or greater. An increase in amount of leveling agent favorably improves the wetting properties of the water-dispersed PSA composition. Thus, it tends to be able to reduce the increase in repellency caused by the added tackifier. In view of reducing contamination of the adherend, in some embodiments, the amount of leveling agent used per 100 parts by weight of base polymer can be 3 parts by weight or less, 2.5 parts by weight or less, 2 parts by weight or less, 1.5 parts by weight or less, 1.2 parts by weight or less, or even 0.8 part by weight or less.

### (Other Additives)

From the standpoint of easy separation from release liner, the water-dispersed PSA composition disclosed herein preferably comprises a silicon compound (typically a silane coupling agent). For the silicon compound, one, two or more species can be used among alkylalkoxysilanes, vinyl group-containing silanes, epoxy group-containing silanes, styryl group-containing silanes, (meth)acryloyl group-containing silanes, amino group-containing silanes, ureido group-containing silanes, mercapto group-containing silanes, isocyanate group-containing silanes, silyl group-containing sulfides and the like. Among them alkylalkoxysilanes are preferable. The molecular weight of the silicon compound may be suitably about 100 or larger (e.g. 200 or larger). It can be about 500 or smaller (e.g. 350 or smaller).

As the alkylalkoxysilane, any of an alkyltrialkoxysilane, dialkyldialkoxysilane, trialkylmonoalkoxysilane, tetraalkoxysilane and phenylalkoxysilane can be used. The alkyl group can be either acyclic or cyclic. Specific examples of the alkylalkoxysilane include methyltrimethoxysilane, ethyltrimethoxysilane, n-propyltrimethoxysilane, n-butyltrimethoxysilane, isobutyltrimethoxysilane, n-hexyltrimethoxysilane, n-octyltrimethoxysilane, n-decyltrimethoxysilane, hexadecyltrimethoxysilane, methyltriethoxysilane, dimethoxydimethylsilane, diethoxydimethylsilane, cyclohexylmethyldimethoxysilane, methoxytrimethylsilane, octadecyldimethylmethoxysilane, phenyltrimethoxysilane, phenyltriethoxysilane, dimethoxydiphenylsilane, diphenylethoxymethylsilane, and dimethoxymethylphenylsilane. In particular, alkyltrialkoxysilanes are preferable.

From the standpoint of obtaining sufficient effects of its addition, the silicon compound content is preferably 0.005 part by weight or greater (e.g. 0.01 part by weight or greater, typically 0.03 part by weight or greater) relative to 100 parts by weight of base polymer (typically an acrylic polymer). From the standpoint of the storage stability, the silicon compound content is preferably less than 1.0 part by weight (e.g. 0.5 part by weight or less, typically 0.3 part by weight or less) relative to 100 parts by weight of base polymer.

If necessary, the PSA composition disclosed herein may comprise an acid or base (ammonia water, etc.) used for such purposes as pH adjustment. Examples of other optional ingredients that may be added in the PSA composition disclosed herein include viscosity modifier, crosslinking-aiding agent, release modifier, plasticizer, softener, filler, colorant (pigment, dye, etc.), antistatic agent, anti-aging agent, UV-ray absorber, antioxidant and light stabilizer. With respect to these various additives, heretofore known species can be used by typical methods. Since these do not particularly characterize the present invention, further details are omitted.

### <PSA Layer>

The PSA layer in the art disclosed herein may be preferably formed by providing an aqueous PSA composition such as the one described above to a given surface followed by drying or curing. When providing (typically applying) the PSA composition, a conventional coater can be used, such as gravure roll coater, reverse roll coater, kiss roll coater, dip roll coater, bar coater, knife coater and spray coater. The PSA layer thickness is not particularly limited. It is usually suitably about 2 μm or greater, preferably about 10 μm or greater, more preferably 20 μm or greater, or possibly 30 μm or greater. The PSA layer thickness is usually suitably about 150 μm or less, preferably about 100 μm or less (e.g., 80 μm or less), more preferably 50 μm or less, yet more preferably 40 μm or less, or possibly 30 μm or less. According to the art disclosed herein, even when the PSA sheet has such a thin PSA layer, it is likely that crosslink inhibitors from the colored layer have reduced influence and reduction of holding power is suppressed.

### <Release Liner>

The release liner protecting and/or supporting the PSA layer is not particularly limited material-wise or construction-wise. A suitable release liner may be selected and used among known release liners. For example, a preferable release liner has at least one surface that has been subjected to release treatment (typically, a surface provided with a release layer made of a release agent). As the substrate constituting this type of release liner (i.e. the substrate to be subjected to release treatment), a suitable substrate can be selected and used among substrates similar to those listed above as the substrate constituting the PSA sheet (e.g. various types of plastic film, paper, fabric, rubber sheet, foam sheet, metal foil, and composites thereof). As the release agent forming the release layer, a known or conventional release agent (e.g. silicone-based, fluorine-based, and long-chain alkyl-type release agents) can be used. Alternatively, a low-adhesion substrate formed of a fluorine-based polymer (e.g. polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer) or a low-polarity polymer (e.g. olefin resins such as polyethylene and polypropylene) may be used as the release liner without applying any particular release treatment to the substrate surface. Such a low-polarity substrate can also be used as the release liner after release treatment to the surface.

The thicknesses of the substrate and the release layer constituting the release liner are not particularly limited and may be suitably selected according to the intended purpose and other considerations. In some preferable embodiments, the overall thickness of the release liner (in a release liner having a release layer on the substrate surface, the overall thickness including the substrate and the release layer) is 1 μm or greater and 100 μm or less, more preferably 10 μm or greater and 80 μm or less, or particularly preferably 25 μm or greater and 75 μm or less.

<Method for Producing PSA sheet with Substrate>

The PSA sheet disclosed herein is produced by a method that comprises obtaining a substrate provided with a colored layer on at least one surface, and providing a PSA layer on the colored layer side surface of the substrate. Here, in preparing the PSA sheet disclosed herein, the method is not particularly limited for providing PSA layers to the first and/or second faces of the substrate. In typical, to each of the first and/or second faces, either method can be preferably applied, selected from the following: (1) a direct method (direct-coating method) where the water-dispersed PSA composition is directly provided (typically applied) to the substrate and dried; and (2) a transfer method where the water-dispersed PSA composition is provided (typically applied) to a release liner and dried to form a PSA layer on the release liner, and then the PSA layer is adhered and transferred (layered) onto the substrate. According to the art disclosed herein, even when the PSA layer is formed by the direct method, crosslinking inhibition is suppressed in the PSA layer, helping to suppress reduction of holding power. Thus, it is particularly meaningful to form PSA layers by the direct method, using the water-dispersed PSA composition disclosed herein. The direct method has the advantage in manufacturing that it does not require a release liner as an in-process paper. With the transfer method, the release liner provided with the PSA composition needs to be heated and dried, for instance, in a dryer. This may require the release liner to be heat resistant (e.g., not curling when heated, etc.). On the other hand, the direct method with no such restrictions advantageously allows selection of a low-cost, environmentally friendly release liner.

When PSA layers are provided to the first and second faces of the substrate to form a double-faced PSA sheet with substrate, the double-faced PSA sheet can be produced by applying the direct method to each face of the substrate (direct/direct method), or the double-faced PSA sheet can be produced by applying the transfer method to one face (typically the face to which a PSA layer is first provided) of the substrate and the direct method to the other face (transfer/direct method). As for a conventional double-faced PSA sheet with colored-layer-containing substrate, it has been difficult to employ the direct method to provide a PSA layer to the colored layer side of the substrate; and therefore, there has been a tendency to adopt a method in which a colored layer is provided only to one face of the substrate and a PSA layer is provided to the colored layer side by a transfer method. On the other hand, according to the present invention, the direct method can be used to favorably provide a PSA sheet to the colored layer side surface of the substrate. Thus, colored layers can be provided to both faces of the substrate, making it possible to reduce the colored layer surface roughness as well as the PSA layer surface roughness, and likely leading to greater adhesive properties.

### <Applications>

The applications of the PSA sheet disclosed herein are not particularly limited. The PSA sheet can be used in various applications where a PSA sheet including a substrate having a colored layer can be applied, for instance, various applications requiring electrical insulation, concealment, light blocking, visibility and designability. The PSA sheet disclosed herein can be favorably used as a PSA sheet to be applied to, for instance, vehicles, building materials and electronic devices. Non-limiting examples include an application as a PSA sheet adhered to modules (e.g., battery modules) inside electronic devices that require electrical insulation. The PSA sheet disclosed herein can also be preferably used in portable electronic devices.

Non-limiting examples of the portable electronic devices include mobile phones, smartphones, tablet PCs, notebook PCs, various wearable devices (e.g., wrist wearables put on wrists such as wrist watches; modular devices attached to bodies with clips, straps, etc.; eye wears including eye glass types (monocular or binocular, including head-mounted pieces); clothing types worn as, for instance, accessories on shirts, socks, hats/caps, etc.; ear-mounted pieces put on ears such as earphones), digital cameras, digital video cameras, acoustic equipment (portable music players, IC recorders, etc.), calculators (e.g., pocket calculators), handheld game devices, electronic dictionaries, electronic notebooks, electronic books, vehicle navigation devices, portable radios, portable TVs, portable printers, portable scanners, and portable modems. In this description, to be “mobile (portable),” it is unsatisfactory to be simply capable of being carried. Instead, it indicates a level of mobility (portability) that allows for relatively easy carriage by hand of an individual (a typical adult).

The matters disclosed by this description include the following:
(1) A PSA sheet that comprises a PSA layer formed from a water-dispersed PSA composition comprising an acrylic polymer as a base polymer, and a support substrate in the form of a sheet having first and second faces, supporting the PSA layer at least on the first face, wherein
   the substrate comprises a colored layer forming the first face, and
   the colored layer comprises an ether-based polyurethane.
(2) The PSA sheet according to (1) above, wherein the acrylic polymer has at least one of the following features:
   being formed from monomers comprising a silanol-forming monomer and crosslinked with silanol groups originating from the silanol-forming monomer (i.e., crosslinked with a silane coupling agent); and
   being crosslinked with one, two or more species of crosslinking agents selected among oxazoline-based crosslinking agents, carbodiimide-based crosslinking agents, epoxy-based crosslinking agents and isocyanate-based crosslinking agents.
(3) The PSA sheet according to (1) or (2) above, wherein the PSA layer has a thickness of 10 μm or greater and 50 μm or less.
(4) The PSA sheet according to any of (1) to (3) above, wherein the substrate comprises a first colored layer forming the first face and a second colored layer forming the second face, and
   a first PSA layer is placed on the first face of the substrate and a second PSA layer is placed on the second face of the substrate.
(5) The PSA sheet according to any of (1) to (4) above, wherein the colored layer is a black-colored layer formed by black color printing.
(6) The PSA sheet according to any of (1) to (5) above, wherein the substrate comprises a resin film formed of a polyester-based resin.
(7) A method for producing a PSA sheet, the method comprising
   obtaining a substrate provided with a colored layer on at least one surface, the colored layer comprising an ether-based polyurethane; and
   directly providing a water-dispersed PSA composition comprising an acrylic polymer as a base polymer to form a PSA layer on the colored layer side surface of the substrate.

### EXAMPLES

Several working examples relating to the present invention are described below, but the present invention is not intended to be limited to these examples. In the description below, “parts” and “%” are based on weight unless otherwise specified.

### (Preparation of Emulsion-Based Polymer α)

To a reaction vessel equipped with a thermometer, stirrer, nitrogen inlet and reflux condenser, were added 0.070 part of surfactant (product name AQUALON KH-1025 available from DKS Co., Ltd.) and 73 parts of distilled water. While stirring, the reaction vessel was purged with nitrogen at room temperature (25° C.) for one hour. To this, was then added 0.10 part of polymerization initiator (product name VA-057 available from FUJIFILM Wako Pure Chemical Corporation) and the resulting mixture was heated to 60° C. To this, at 60° C., was added an emulsion over 4 hours to carry out polymerization. The emulsion was obtained by emulsifying 85 parts of 2-ethylhexyl acrylate (2EHA), 13 parts of methyl acrylate (MA), 1.2 parts of acrylic acid (AA), 0.75 part of methacrylic acid (MAA), 0.035 part of t-dodecanethiol (chain transfer agent), 0.02 part of 3-methacryloxypropyltrimethoxysilane (product name KBM-503 available from Shin-Etsu Chemical Co., Ltd.) and 1.9 parts of surfactant (product name AQUALON KH-1025 available from DKS Co., Ltd.) with 30 parts of distilled water. The reaction mixture was allowed to cool to room temperature and adjusted to pH 6 with 10% ammonia water as a pH adjuster to prepare emulsion-based Polymer α.

### (Preparation of PSA Composition A)

For every 100 parts of non-volatiles of emulsion-based Polymer α, were added 35.4 parts of tackifier resin (product name TAMANOL E-200-NT available from Arakawa Chemical Industries, Ltd.), 3.67 parts of polyacrylic acid (Mw=20·10⁴; product name ARON A-10H available from Toagosei Co., Ltd.), 0.89 part of leveling agent (product name NEOCOL SW—C available from Kao Corporation) and 1.0 part of carboxylic acid-based copolymer (product name ARON B-500 available from Toagosei Co., Ltd.). The resulting mixture was diluted and neutralized with distilled water and 10% ammonia water to prepare emulsion-based PSA Composition A (25% non-volatiles).

### (Preparation of Emulsion-Based Polymer β)

To a reaction vessel equipped with a thermometer, stirrer, nitrogen inlet and reflux condenser, were added 0.070 part of surfactant (product name AQUALON KH-1025 available from DKS Co., Ltd.) and 69 parts of distilled water. While stirring, the reaction vessel was purged with nitrogen at room temperature (25° C.) for one hour. To this, was then added 0.10 part of polymerization initiator (product name VA-057 available from FUJIFILM Wako Pure Chemical Corporation) and the resulting mixture was heated to 60° C. To this, was added an emulsion at 60° C. over 4 hours to carry out polymerization. The emulsion was obtained by emulsifying 41 parts of 2EHA, 34 parts of butyl acrylate (BA), 23 parts of methyl methacrylate (MMA), 0.7 part of AA, 0.54 part of MAA, 0.02 part of t-dodecanethiol (chain transfer agent) and 1.9 parts of surfactant (product name AQUALON KH-1025 available from DKS Co., Ltd.) with 32 parts of distilled water. The reaction mixture was allowed to cool to room temperature and adjusted to pH 6 with 10% ammonia water as a pH adjuster to prepare emulsion-based Polymer β.

### (Preparation of PSA Composition B)

For every 100 parts of non-volatiles of emulsion-based Polymer β, were added 35.4 parts of tackifier resin (product name TAMANOL E-200-NT available from Arakawa Chemical Industries, Ltd.), 3.67 parts of polyacrylic acid (Mw=20·10⁴; product name ARON A-10H available from Toagosei Co., Ltd.), 0.89 part of leveling agent (product name NEOCOL SW—C available from Kao Corporation) and 1.0 part of carboxylic acid-based copolymer (product name ARON B-500 available from Toagosei Co., Ltd.). The resulting mixture was diluted and neutralized with distilled water and 10% ammonia water to obtain a PSA composition. The PSA composition was diluted and neutralized with water to prepare Composition β. To the resulting Composition β, was added 0.1 part of carbodiimide-based crosslinking agent (product name CARBODILITE V-04 available from Nisshinbo Holdings, Inc.). The resultant was stirred and mixed to prepare emulsion-based PSA Composition B.

### (Preparation of PSA Composition C)

To Composition β, instead of adding 0.1 part of carbodiimide-based crosslinking agent, was added 0.1 part of oxazoline-based crosslinking agent (product name EPOCROS WS-500 Nippon Shokubai Co., Ltd.). Otherwise in the same manner as the preparation method for emulsion-based PSA Composition B, was prepared emulsion-based PSA Composition C.

### (Preparation of PSA Composition D)

To Composition β, instead of adding 0.1 part of carbodiimide-based crosslinking agent, was added 1 part of isocyanate-based crosslinking agent (product name BURNOCK 5010 available from DIC Corporation). Otherwise in the same manner as the preparation method for emulsion-based PSA Composition B, was prepared emulsion-based PSA Composition D.

### (Preparation of PSA Composition E)

To Composition β, instead of adding 0.1 part of carbodiimide-based crosslinking agent, was added 1 part of epoxy-based crosslinking agent (product name DENACOL EX-313 available from Nagase ChemteX Corporation). Otherwise in the same manner as the preparation method for emulsion-based PSA Composition B, was prepared emulsion-based PSA Composition E.

### (Preparation of Solvent-Based Polymer γ)

To a reaction vessel equipped with a stirrer, thermometer, nitrogen inlet, reflux condenser and addition funnel, were added 90 parts of BA, 30 parts of 2EHA, 3 parts of AA and 0.05 part of 4-hydroxybutyl acrylate (4-HBA) as monomers; 2,2′-azobisisobutyronitrile (AIBN) as a polymerization initiator; and toluene as a polymerization solvent. The reaction was carried out at 60° C. for 6 hours to obtain solvent-based Polymer Y.

### (Preparation of PSA Composition F)

For every 100 parts of the resulting solvent-based Polymer γ, were added 30 parts of polymerized rosin ester resin (product name PENSEL D-125 available from Arakawa Chemical Industries, Ltd.) and 2 parts of isocyanate-based crosslinking agent (product name CORONATE L available from Tosoh Corporation). The resultant was stirred and mixed to prepare solvent-based PSA Composition F.

### (Preparation of PSA Composition G)

For every 100 parts of solvent-based Polymer γ, were added 30 parts of polymerized rosin ester resin (product name PENSEL D-125 available from Arakawa Chemical Industries, Ltd.) and 0.03 part of epoxy-based crosslinking agent (product name TETRAD-C available from Mitsubishi Gas Chemical Company, Inc.). The resultant was stirred and mixed to prepare solvent-based PSA Composition G.

### Example 1

(Preparation of PSA Sheet with Black-Printed Substrate by Transfer Method)

To a release liner (product name PET-75-SCA1 available from Fuji Corporation), PSA Composition A was applied and dried to a dry thickness of 10 μm. Was obtained a substrate film (˜52 μm in total thickness) with black-colored layer (about 1-2 μm thick) comprising an ether-based polyurethane as the primary component, with the black layer printed on one face of a 50 μm thick PET resin film (product name LUMMIROR S105 available from Toray Industries, Inc.). The release liner coated with PSA Composition A was adhered to the black-printed side surface of the substrate film to transfer the PSA layer and obtain a PSA sheet with black-printed substrate by transfer method according to this example.

(Preparation of PSA Sheet with Black-Printed Substrate by Direct Method)

As described above, was obtained a substrate film (˜52 μm in total thickness) with black-colored layer (about 1-2 μm thick) comprising an ether-based polyurethane as the primary component, with the black layer printed on one face of a 50 μm thick PET resin film (product name LUMMIROR S105 available from Toray Industries, Inc.). To the black-printed side surface of the substrate film, PSA Composition A was applied and dried to a dry thickness of 10 μm. This was adhered to a release liner (product name PET-75-SCA1 available from Fuji Corporation) to obtain a PSA sheet with black-printed substrate by direct method according to this example.

(Preparation of PSA Sheet with Raw Substrate by Direct Method)

As a substrate film, was obtained a PET resin film (product name LUMMIROR S105 available from Toray Industries, Inc.; which may be referred to as a raw substrate or raw substrate film, hereinafter) without black color printing. To one face of the raw substrate film, PSA Composition A was applied and dried to a dry thickness of 10 μm. This was adhered to a release liner (product name PET-75-SCA1 available from Fuji Corporation) to obtain a PSA sheet with raw substrate by direct method according to this example.

### Examples 2-5 and Comparative Examples 1-2

Using the various PSA compositions shown in Table 1 in place of PSA Composition A, but otherwise in the same manner as Example 1, were prepared PSA sheets with black-printed substrates by transfer method, PSA sheets with black-printed substrates by direct method and PSA sheets with raw substrates by direct method according to Examples 2-5 and Comparative Examples 1-2.

Table 1 summarizes the features of the PSA sheet of each example.

### [Holding Power Test]

### (Holding Power Test for Initial PSA Sheet)

The PSA sheets (PSA sheets with black-printed substrates by transfer method, PSA sheets with black-printed substrates by direct method and PSA sheets with raw substrates by direct method) according to the respective examples were cut into a 10 mm wide and 100 mm long size to prepare a measurement sample. In an environment at 23° C. and 50% RH, to a Bakelite plate (phenol resin plate) as an adherend, was press-bonded the adhesive face of the measurement sample over a 10 mm wide and 20 mm long bonding area with a 2 kg roller moved back and forth once. The adherend with the measurement sample was left still for 30 minutes in the environment at 23° C. and 50% RH. Subsequently, to the test piece, was applied a 1 kg load. Based on JIS Z 0237, with the applied load, this was left in an environment at 40° C. for one hour. It was observed whether or not the measurement sample peeled off from the adherend and fell off within 1 hour. OK is given if it didn't fall and NG if it fell off.

### (Holding Power Test for Aged PSA Sheet)

In an environment at 50° C. and 50% RH, the PSA sheets (PSA sheets with black-printed substrates by transfer method, PSA sheets with black-printed substrates by direct method and PSA sheets with raw substrates by direct method) according to the respective examples were left still for aging for 3 days. Subsequently, each PSA sheet was cut into a 10 mm wide and 100 mm long size to prepare a measurement sample. In an environment at 23° C. and 50% RH, to a Bakelite plate (phenol resin plate) as an adherend, was press-bonded the adhesive face of the measurement sample over a 10 mm wide and 20 mm long bonding area with a 2 kg roller moved back and forth once. The adherend with the measurement sample was left still for 30 minutes in the environment at 23° C. and 50% RH. Subsequently, to the test piece, was applied a 1 kg load. Based on JIS Z 0237, with the applied load, this was left in an environment at 40° C. for one hour. It was observed whether or not the measurement sample peeled off from the adherend and fell off within 1 hour. OK is given if it didn't fall and NG if it fell off.

### (Evaluation of Holding Power)

Based on the holding power test results of the initial and aged PSA sheets, the holding power of the PSA sheet according to each example was graded into three levels. In particular, when the holding power test results of both the initial and aged PSA sheets were OK, it was graded A (excellent); when the holding power test result of the aged PSA sheet was OK while the holding power test result of the initial PSA sheet was NG, it was graded B (good); and when the holding power test results of both the initial and aged PSA sheets were NG, it was graded C (poor). The results are shown in Table 1.

TABLE 1

| | | | | | | | | Comp. | Comp. |
|---|---|---|---|---|---|---|---|---|---|
| | | | Ex. 1 | Ex. 2 | Ex. 3 | Ex. 4 | Ex. 5 | Ex. 1 | Ex. 2 |
| PSA composition | | | A | B | C | D | E | F | G |
| Acrylic polymer | | | α | β | β | β | β | γ | γ |
| Crosslinker | | | Silanol | Carbodiimide | Silanol | Isocyanate | Epoxy | Isocyanate | Epoxy |
| Holding | Black-printed | Direct | A | A | A | A | B | C | C |
| power | substrate | Transfer | A | B | B | B | B | B | C |
| test | Raw substrate | Direct | A | B | B | B | B | B | B |

As compared with Comparative Examples 1 and 2 with PSA layers formed from solvent-based PSA compositions, the PSA sheets of Examples 1 to 5 with PSA layers formed from water-dispersed PSA compositions had good holding power even in an embodiment where the direct method was employed to provide PSA to the black-printed surface of the substrate. Especially, the PSA sheet of Example 1 showed stable and excellent holding power, with the PSA sheet having a PSA layer crosslinked with a silanol-based crosslinking agent (silanol-forming monomer).

Although specific embodiments of the present invention have been described in detail above, these are merely for illustrations and do not limit the scope of claims. The art according to the claims includes various modifications and changes made to the specific embodiments illustrated above.

What is claimed is:

1. A pressure-sensitive adhesive sheet that comprises a pressure-sensitive adhesive layer formed from a water-dispersed pressure-sensitive adhesive composition comprising an acrylic polymer as a base polymer, and a support substrate sheet having first and second faces, supporting the pressure-sensitive adhesive layer at least on the first face, wherein
the substrate comprises a colored layer forming the first face, and
the colored layer comprises an ether-based polyurethane.

2. The pressure-sensitive adhesive sheet according to claim 1, wherein the acrylic polymer has at least one of the following features:
being formed from monomers comprising a silanol-forming monomer and crosslinked with silanol groups originating from the silanol-forming monomer; and
being crosslinked with one, two or more species of crosslinking agents selected among oxazoline-based crosslinking agents, carbodiimide-based crosslinking agents, epoxy-based crosslinking agents and isocyanate-based crosslinking agents.

3. The pressure-sensitive adhesive sheet according to claim 1, wherein the pressure-sensitive adhesive layer has a thickness of 10 μm or greater and 50 μm or less.

4. The pressure-sensitive adhesive sheet according to claim 1, wherein the substrate comprises a first colored layer forming the first face and a second colored layer forming the second face, and
a first pressure-sensitive adhesive layer is placed on the first face of the substrate and a second pressure-sensitive adhesive layer is placed on the second face of the substrate.
